(19) United States
(12) Patent Application Publication
(10) Pub. No.: US 2008/0097012 A1
(43) Pub. Date: Apr. 24, 2008

(54) Polyoxymethylene Resin Composition Having An Excellent Heat Stability

(75) Inventors: Tak-Kyu Kim, Kyungki-do (KR); Chung-Ryol Jeong, Kyungki-do (KR); Do-Young Lee, Kyungki-do (KR)

Correspondence Address: MCDERMOTT WILL & EMERY LLP, 18191 VON KARMAN AVE., SUITE 500, IRVINE, CA, 92612-7108, US

(73) Assignee: KOREA ENGINEERING PLASTIC CO., LTD.

(21) Appl. No.: 11/664,705

(22) PCT Filed: Oct. 6, 2005
(86) PCT No.: PCT/KR05/03300

§ 371 Date: Apr. 5, 2007

(30) Foreign Application Priority Data
Oct. 8, 2004 (KR) 10-2004-0080409

(51) Int. Cl. C08K 5/3492

(52) U.S. Cl. 524/100

(57) ABSTRACT

Disclosed herein is a polyoxymethylene resin composition which comprises 100 parts by weight of a polyoxymethylene polymer (A), 0.005-2 parts by weight of an amine-substituted triazine compound (B), 0.01-5 parts by weight of a compound (C) prepared by grafting 0.05-5 parts by weight of anhydrous maleic acid onto an ethylene-propylene copolymer and an ethylene-propylene terpolymer, and 0.001-2 parts by weight of 1,12-dodecanedicarboxylic acid dihydrazide (D). The polyoxymethylene resin composition is highly thermally stable, and shows reduced generation of formaldehyde gas, particularly, during molding and from final molded products.

### TECHNICAL FIELD

The present invention relates to a polyoxymethylene resin composition having excellent heat stability and reduced generation of formaldehyde gas, and more specifically to a polyoxymethylene resin composition having excellent heat stability and reduced generation of formaldehyde gas, particularly, during molding and from final molded products.

### BACKGROUND ART

Generally, polyoxymethylene polymers are superior in mechanical properties, creep resistance, fatigue resistance and friction wear resistance. Based on these advantages, polyoxymethylene polymers are used in a variety of electrical and electronic components and in a wide range of applications that require complex characteristics, such as mechanical mechanisms. However, since polyoxymethylene polymers have poor heat(thermal) stability, they tend to degrade due to external thermal or mechanical impact or the presence of additives during molding and processing, thus expelling a large amount of formaldehyde gas, which is a degradation by-product of polyoxymethylene resins. In addition, the by-product remains in final molded products, posing health and environmental hazards.

Many approaches aimed at improving the thermal stability of polyoxymethylene have been proposed. Various proposals to use additives, such as amines, amides and hydrazines, capable of reacting with degradation gases, e.g., formaldehyde, generated due to thermal degradation have been made to improve the thermal stability of polyoxymethylene. For example, Japanese Patent Laid-open No. Hei 10-1592 describes the addition of an acrylamide and a boric acid compound to a polyoxymethylene resin. Further, Japanese Patent Laid-open No. Sho 59-213752 describes the addition of an alanine compound to a polyoxymethylene resin. According to these methods, however, since the additives are thermally unstable, yellowing of the polymers is caused. This yellowing results in the formation of mold deposits due to bleed-out of the additives, thus limiting the improvement of thermal stability.

Methods for reducing the amount of formaldehyde gas generated have been introduced. For example, Japanese Patent Laid-open No. Hei 4-345648 describes the addition of 0.01˜5.0 parts by weight of a hydrazide compound to 100 parts by weight of a polyacetal resin. Further, Japanese Patent Laid-open No. Hei 10-298401 describes the addition of 0.01˜5% by weight of a C_{4˜12} aliphatic dihydrazide to a polyoxymethylene resin. Japanese Patent Laid-open No. Hei 10-36630 discloses a composition comprising polyoxymethylene, a sterically hindered phenolic antioxidant and a hydrazide compound. Japanese Patent Laid-open No. Hei 10-36524 discloses a resin composition comprising a thermoplastic resin and a hydrazide compound. However, these resin compositions have the problem that the generation of formaldehyde is not sufficiently reduced.

Alternative methods have been suggested to improve the thermal stability by stabilizing the ends of polyoxymethylene molecules. For example, a polyoxymethylene homopolymer is prepared by polymerizing formaldehyde, trioxane and the like in the presence of an anionic catalyst, and capping unstable ends with a particular material. Specifically, Japanese Patent Publication No. Sho 33-6099 and U.S. Pat. No. 2,964,500 and Japanese Patent Publication No. Sho 36-3492 disclose methods for the urethanization of terminal hydroxyl groups by reacting an isocyanate with the terminal groups. These methods, however, have the problems that the oxymethylene backbone may be easily broken due to some mechanisms, including solvolysis, and thermally unstable polymers may be prepared due to the presence of uncapped terminal groups.

A method has been suggested to overcome the above-mentioned problems of polyoxymethylene homopolymers. According to this method, first, a copolymer is prepared by copolymerizing formaldehyde and trioxane with a particular comonomer, i.e., a cyclic ether (e.g., oxidized ethylene) and a cyclic formal (e.g., dioxolane), in the presence of a catalyst. Thereafter, the copolymer is randomly distributed and introduced in a polyoxymethylene homopolymer. However, since the copolymer also has highly unstable end groups, it must undergo a stabilization process.

Much research has been conducted to provide technical solutions to the above-mentioned problems. Most patent publications have mainly focused on methods for forcibly degrading unstable end sites to comonomeric units. For example, Japanese Patent Publication Nos. Sho 60-63216 and Sho 60-69121 suggest methods for stabilizing unstable ends by degrading the ends using an aqueous alkaline solution (pH >7) in a heterogeneous medium after polymerization. U.S. Pat. No. 1,407,145 suggests a method for stabilizing unstable ends by hydrolyzing the ends using an antacid, an antioxidant, and the like, in a basic alcohol and a heterogeneous medium. However, no satisfactory results could be achieved by these methods.

On the other hand, a method for removing unstable ends by making a polyoxymethylene copolymer into a solution in a homogeneous phase is described in Japanese Patent Publication No. Sho 43-18714. However, the troublesome problems of this method in terms of processing are that polymerization products are deposited in a polymerization bath and the removal of solvents is inevitable. Some purification techniques in homogeneous phases have been proposed to overcome low purification efficiency in a medium. For example, a method for removing volatile materials from a polymer using a three-stage rotary disk type kneader (Japanese Patent Publication No. Sho 62-119219). However, this method incurs considerable processing time to completely remove unstable ends and has a difficulty in completely stabilizing the ends.

### DISCLOSURE OF INVENTION

### Technical Problem

Thus, it is one object of the present invention to provide a polyoxymethylene resin composition which comprises: a material capable of imparting stabilization effects to a polymer having unstable ends in a stabilization step during preparation of polyoxymethylene, without causing the above-mentioned problems, thereby ensuring stabilization of the polymer and achieving excellent thermal stability; and a nitrogen-containing compound, leading to a reduction in the amount of formaldehyde gas generated during molding and from final molded products.

It is another object of the present invention to provide molded products manufactured from the polyoxymethylene resin composition.

### Technical Solution

In accordance with an aspect of the present invention for achieving the above objects, there is provided a polyoxymethylene resin composition comprising 100 parts by weight of a polyoxymethylene polymer (A), 0.005˜2 parts by weight of an amine-substituted triazine compound (B), 0.01˜5 parts by weight of a compound (C) prepared by grafting 0.05˜5 parts by weight of anhydrous maleic acid onto an ethylene-propylene copolymer and an ethylene-propylene terpolymer, and 0.001˜2 parts by weight of 1,12-dodecanedicarboxylic acid dihydrazide (D).

### BEST MODE FOR CARRYING OUT THE INVENTION

The present invention will now be described in detail.

The polyoxymethylene polymer (A) used in the present invention may be a homopolymer consisting of the oxymethylene monomer represented by Formula 1 below:
—(—CH₂O—)— Formula 1

or a random copolymer consisting of the monomer of Formula 1 and a monomer represented by Formula 2 below:
[(CX₁X₂)xO] Formula 2

wherein X₁ and X₂, which may be the same or different, are each independently selected from the group consisting of hydrogen, alkyl groups and aryl groups, and x is an integer from 2 to 6.

The random copolymer preferably has a molecular weight of 10,000 to 200,000 g/mol.

The oxymethylene homopolymer may be prepared by polymerizing formaldehyde or a cyclic oligomer thereof, i.e. trioxane. The oxymethylene copolymer consisting of the monomer of Formula 1 and the monomer of Formula 2 may be prepared by randomly copolymerizing formaldehyde or a cyclic oligomer thereof with a cyclic ether represented by Formula 3 below:

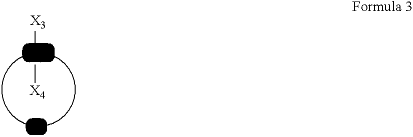

wherein X₃ and X₄, which may be the same or different, are each independently selected from hydrogen and alkyl groups and may be bonded to the same carbon atom or different carbon atoms, and n is an integer from 2 to 6; or a cyclic formal represented by Formula 4 below:

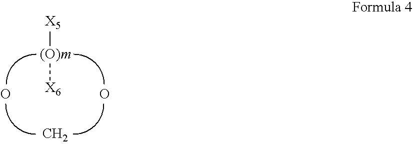

wherein X₅ and X₆, which may be the same or different, are each independently selected from hydrogen and alkyl groups and may be bonded to the same carbon atom or different carbon atoms, and m is an integer from 2 to 6.

As suitable cyclic ethers used for the random copolymerization, there can be mentioned ethyleneoxide, propyleneoxide, butyleneoxide, phenyleneoxide, and the like. As suitable cyclic formals, there can be used, for example, 1,3-dioxolane, diethyleneglycol formal, 1,3-propanediol formal, 1,4-butanediol formal, 1,3-dioxepane formal, and 1,3,6-trioxocane. One or two monomers selected from ethyleneoxide, 1,3-dioxolane, and 1,4-butanediolformal are preferably used. These monomers are added to trioxane or formaldehyde as a main monomer, followed by random polymerization in the presence of a Lewis acid as a catalyst, giving an oxymethylene copolymer with a melting point of 150° C. or higher that has two or more bonded carbon atoms in the backbone of the copolymer.

The molar ratio of the bonded oxymethylene units to the oxymethylene repeating units in the oxymethylene copolymer is 0.05˜50:1 and preferably 0.1˜20:1.

Examples of the polymerization catalyst used for the preparation of theoxymethylene polymer include BF₃□OH, BF₃.OEt₂ (Et=ethyl), BF₃.OBu₂(Bu=butyl), BF₃.CH₃CO₂H, BF₃.PF₅.HF, and BF₃-10-hydroxyacetphenol. BF₃.OEt and BF₃.OBu₂ are preferred. It is preferred that the amount of the polymerization catalyst added be in the range of 2×10⁻⁶ moles to 2×10⁻² moles with respect to one mole of trioxane.

The polymerization can be performed by bulk polymerization, suspension polymerization, or solution polymerization. The polymerization temperature is between 0° C. and 100° C., preferably between 20° C. and 80° C.

General deactivating agents for deactivating the activity of the catalyst remaining after the polymerization include tertiary amines, e.g., triethylamine, cyclic sulfur compounds, e.g., thiophene, phosphorus compounds, e.g., triphenylphosphine, and the like. All these deactivating agents are Lewis basic materials having an unshared pair of electrons and form complexes with catalysts.

Chain transfer agents, such as alkyl-substituted phenols and ethers can be used during preparation of the polyoxymethylene polymer. Alkylethers, such as dimethoxymethane, are particularly preferred.

The amine-substituted triazine compound (B) used in the present invention is an additive for further improving the thermal stability of the composition according to the present invention. Examples of the amine-substituted triazine compound (B) include guanamine, melamine, N-butylmelamine, N-phenylmelamine, N,N-diphenylmelamine, N,N-diallylmelamine, N,N′,N″-triphenylmelamine, N,N′,N″-trimethylolmelamine, benzoguanamine, 2,4-diamino-6-methyl-sym-triazine, 2,4-diamino-6-butyl-sym-triazine, 2,4-diamino-6-benzyloxy-sym-triazine, 2,4-diamino-6-butoxy-sym-triazine, 2,4-diamino-6-cyclohexyl-sym-triazine, 2,4-diamino-6-chloro-sym-triazine, 2,4-diamino-6-mercapto-sym-triazine, 2-oxy-4,6-diamino-sym-triazine (ameline), and N,N,N′,N′-tetracyanoethyl benzoguanamine. Of these compounds, most preferred is the melamine represented by Formula 5 below:

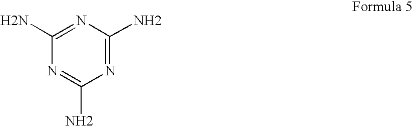

The amount of the amine-substituted triazine compound (B) used in the resin composition of the present invention is 0.005˜2 parts by weight, preferably 0.01˜1 parts by weight, based on 100 parts by weight of the polyoxymethylene polymer (A). When the amine-substituted triazine compound (B) is used in an amount of less than 0.005 parts by weight, improvement in thermal stability is negligible. On the other hand, when the amine-substituted triazine compound (B) is used in an amount exceeding 2 parts by weight, the physical properties of final molded products are deteriorated.

The compound (C) prepared by grafting 0.05˜5 parts by weight of anhydrous maleic acid onto an ethylene-propylene copolymer and an ethylene-propylene terpolymer a component that stabilizes unstable ends of the polyoxymethylene polymer to further improve the thermal stability of the resin composition according to the present invention. The ethylene-propylene copolymer used herein has an ethylene content of 10˜90% by weight, and the ethylene-propylene terpolymer has an ethylene content of 10˜90% by weight and a diene content of 0.1˜20% by weight. The weight ratio of the ethylene-propylene copolymer to the ethylene-propylene terpolymer is in the range of 10˜90:90˜10. One useful example of the component (C) is HIGHLER P-0424K (Doo. Hyun Co., Ltd.). The component (C) can be added in the form of a pellet or a frozen and pulverized powder.

The amount of the component (C) used in the resin composition of the present invention is 0.01˜5 parts by weight, preferably 0.01˜2 parts by weight, based on 100 parts by weight of the polyoxymethylene polymer (A). When the component (C) is used in an amount of less than 0.01 parts by weight, improvement in thermal stability is negligible. On the other hand, when the component (C) is used in an amount exceeding 5 parts by weight, the physical properties of final molded products are deteriorated.

The 1,12-dodecanedicarboxylic acid dihydrazide (D) used in the present invention is represented by Formula 6 below:

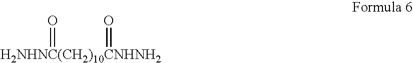

The 1,12-dodecanedicarboxylic acid dihydrazide (D) is a component for reducing the amount of formaldehyde gas generated during molding of the polyoxymethylene resin composition and from final molded products.

The amount of the component (D) used in the resin composition of the present invention is 0.001˜2.0 parts by weight, preferably 0.005˜1.0 parts by weight, based on 100 parts by weight of the polyoxymethylene polymer (A). When the component (D) is used in an amount of less than 0.001 parts by weight, improvement in thermal stability is negligible. On the other hand, when the component (D) is used in an amount exceeding 2 parts by weight, yellowing of final molded products takes place.

Further, a sterically hindered phenol (E) is preferably added to further improve the thermal stability of the resin composition according to the present invention. Examples of suitable sterically hindered phenols include 2,2′-methylene-bis(4-methyl-6-t-butylphenol), 4,4′-methylene-bis(2,6-di-t-butylphenol), 1,3,5-trimethyl-2,4,6-tris(3,5-di-t-butyl-4-hydroxybenzyl)benzene, 2,5-di-t-butyl-4-hydroxybenzyl dimethylamine, stearyl-3,5-di-t-butyl-4-hydroxybenzyl phosphonate, diethyl-3,5-di-t-butyl-4-hydroxybenzyl phosphonate, 2,6,7-trioxa-1-phospho-bicyclo[2,2,2]-octo-4-yl-methyl-3,5-di-t-butyl-4-hydroxyhydro cinnamate, 3,5-di-t-butyl-4-hydroxyphenyl-3,5-distearyl-thiotriazylamine, 2-(2′-hydroxy-3′,5′-di-t-butylphenyl)-5-chlorobenzotriazole, 2,6-di-t-butyl-4-hydroxymethylphenol, 2,4-bis-(n-octylthio)-6-(4-hydroxy-3,5-di-t-butylallylino)-1,3,5-triazine, N,N′-hexamethylenebis(3,5-di-t-butyl-4-hydroxy-hydrocinnamamide), octadecyl-3-(3,5-di-butyl-4-hydroxyphenyl)propionate, 1,6-hexanediol-bis[3-(3,5-di-t-butyl-4-hydroxyphenyl)propionate], pentaerythrityl-tetrakis[3-(3,5-di-t-butyl-4-hydroxyphenyl)propionate], triethylene glycol-bis[3-(3,5-dimethyl-4-hydroxyphenyl)propionate], triethylene glycol-bis-3-(3-t-butyl-4-hydroxy-5-methylphenyl)propionate, triethylene glycol-bis[3-(3,5-di-t-butyl-4-hydroxyphenyl)propionate], and 2,2′-thiodiethyl-bis[3-(3,5-di-tbutyl-4-hydroxyphenyl)propionate.

Of these, preferred is triethylene glycol-bis-3-(3-t-butyl-4-hydroxy-5-methylphenyl)propionate.

The amount of the component (E) used is 0.01˜3 parts by weight, preferably 0.01˜1 parts by weight, based on 100 parts by weight of the polyoxymethylene polymer (A). When the component (E) is used in an amount of less than 0.01 parts by weight, improvement in thermal stability is negligible. On the other hand, when the component (E) is used in an amount exceeding 3 parts by weight, final molded products show deteriorated physical properties and bad surface state.

Further, at least one metal compound (F) selected from the group consisting of hydroxides, inorganic acid salts, organic acid salts and alkoxides of alkali metals and alkaline earth metals is preferably added to further improve the thermal stability of the resin composition according to the present invention. Examples of the inorganic acid salts include carbonates, phosphates, silicates, and borates. Examples of the organic acid salts include laurates, stearates, oleates, and behenates. Examples of the alkoxides include C alkoxides, such as methoxides and ethoxides. Among these metal compounds, alkaline earth metal hydroxides, e.g., magnesium hydroxide, are preferred.

The amount of the component (F) used in the present invention is 0.01˜1 parts by weight, preferably 0.01˜0.5 parts by weight, based on 100 parts by weight of the polyoxymethylene polymer (A). When the component (F) is used in an amount of less than 0.01 parts by weight, improvement in thermal stability is negligible. On the other hand, when the component (F) is used in an amount exceeding one part by weight, the physical properties of final molded products are deteriorated and gas production is greatly increased.

### MODE FOR THE INVENTION

The present invention will now be described in more detail with reference to the following examples and comparative examples. However, these examples are not to be construed as limiting the scope of the invention.

The physical properties described in the examples were measured in accordance with the following procedures.

(1) Amount of CH₂O Generated at High Temperature

2 g of a polyoxymethylene resin was heated to 222° C. while nitrogen was fed thereto to generate CH₂O, and then the gas was collected in ice-water. The degree of coloration of the ice-water was analyzed using a UV spectrophotometer to measure the amount of CH₂O generated. A lower value indicates superior thermal stability.

(2) Amount of CH₂O Generated from Molded Product (a)

A polyoxymethylene resin was molded to manufacture a product having a size of 100 mm×40 mm×2 mm. The molded product was fixed in a one-liter bottle containing 50 ml of water so as not to touch the water, and then the bottle was sealed. The bottle was allowed to stand at 60° C. for 3 hours. The degree of coloration of the water was analyzed using a UV spectrophotometer to measure the amount of CH₂O collected in the water. A lower value indicates superior thermal stability.

(3) Amount of CH₂O Generated from Molded Product (b)

A polyoxymethylene resin was molded to manufacture a product having a size of 140 mm×18 mm×6 mm. The molded product fixed in a one-liter bottle containing 50 ml of water so as not to touch the water, and then the bottle was sealed. The bottle was allowed to stand at 80° C. for 3 hours. The degree of coloration of the water was analyzed using a UV spectrophotometer to measure the amount of CH₂O collected in the water. A lower value indicates superior thermal stability.

(4) Color

A polyoxymethylene resin was fed to a general injection molder, stayed at 220° C. for 30 minutes, and molded into a disk test piece (diameter: 100 mm, thickness: 2 mm). The occurrence of yellowing in the test piece was observed by visual examination.

‘White’ indicates no occurrence of yellowing, and ‘yellow’ indicates occurrence of severe yellowing.

### PREPARATIVE EXAMPLE 1

### Preparation of Polyoxymethylene Copolymer Used in the Present Invention

100 parts by weight of trioxane and 4.5 parts by weight of 1,3-dioxolane as a comonomer were polymerized in the presence of BF₃O(Et)₂ as a catalyst. Methylal was used as a chain transfer agent and then the catalyst was deactivated with triphenylphosphine to give a polyoxymethylene copolymer.

### EXAMPLE 1

First, a 500 cc kneader equipped with two pairs of Σ type blades was maintained at 230° C. 0.05 parts by weight of melamine as an amine-substituted triazine compound, 0.01 parts by weight of HIGHLER P-0424K (ethylene-propylene copolymer:ethylene-propylene terpolymer=50:50 (w/w), D.H Co., hereinafter, referred to as ‘PK’), 0.01 parts by weight of 1,12-dodecanedicarboxylic acid dihydrazide (hereinafter, referred to as ‘N-12’), 0.3 parts by weight of triethyleneglycol-bis-3-(3-tert-butyl-4-hydroxy-5-methylphenyl)propionate (Irganox 245, Ciba Geigy) and 0.05 parts by weight of magnesium hydroxide (Mg(OH)₂) were added to 100 parts by weight of the polyoxymethylene copolymer prepared in Preparative Example 1, and stayed in the kneader under a nitrogen atmosphere for 40 minutes to obtain a resin. The physical properties of the resin were evaluated, and the obtained results are shown in Table 1 below.

### EXAMPLES 2˜10

The procedure of Example 1 was repeated, except that N-12 was added in amounts of 0.001, 0.005, 0.05, 0.10, 0.20, 0.30, 0.50, 1.00 and 2.00 parts by weight (Examples 2 to 10, respectively). The obtained results are shown in Table 1.

### EXAMPLES 11˜19

The procedure of Example 1 was repeated, except that melamine was added in an amount of 0.10 parts by weight, N-12 was added in an amount of 0.05 parts by weight, and PK was added in amounts of 0.05, 0.10, 0.20, 0.30, 0.50, 1.0, 2.0, 3.0 and 5.0 parts by weight (Examples 11 to 19, respectively). The results are shown in Table 1.

### EXAMPLE 20

The procedure of Example 1 was repeated, except that melamine was added in an amount of 0.10 parts by weight, PK was added in an amount of 0.10 parts by weight, and N-12 was added in an amount of 0.10 parts by weight. The results are shown in Table 1.

### EXAMPLE 21

The procedure of Example 1 was repeated, except that melamine was added in an amount of 0.10 parts by weight, PK was added in an amount of 0.50 parts by weight, and N-12 was added in an amount of 0.20 parts by weight. The results are shown in Table 1.

### COMPARATIVE EXAMPLE 1

The procedure of Example 1 was repeated, except that no N-12 was added. The results are shown in Table 2.

### COMPARATIVE EXAMPLE 2

The procedure of Example 1 was repeated, except that N-12 was added in an amount of 3 parts by weight. The results are shown in Table 2.

### COMPARATIVE EXAMPLE 3

The procedure of Example 11 was repeated, except that no PK was added. The results are shown in Table 2.

### COMPARATIVE EXAMPLE 4

The procedure of Example 11 was repeated, except that PK was added in an amount of 7 parts by weight. The results are shown in Table 2.

### COMPARATIVE EXAMPLE 5

The procedure of Example 1 was repeated, except that isophthalic acid dihydrazide was added in an amount of 0.10 parts by weight instead of N-12. The results are shown in Table 2.

### COMPARATIVE EXAMPLE 6

The procedure of Comparative Example 5 was repeated, except that PK was added in an amount of 0.10 parts by weight. The results are shown in Table 2.

### COMPARATIVE EXAMPLE 7

The procedure of Example 1 was repeated, except that 0.10 parts by weight of urea (Duksan Pure Chemicals Co., Ltd.) was added to N-12. The results are shown in Table 2.

### COMPARATIVE EXAMPLE 8

The procedure of Comparative Example 7 was repeated, except that PK was added in an amount of 0.10 parts by weight. The results are shown in Table 2.

TABLE 1

| | Amount of CH₂O | Amount of CH₂O | Amount of CH₂O | |
|---|---|---|---|---|
| | generated at | generated | generated | |
| | high temperature | from molded | from molded | |
| Example No. | (ppm) | product (a) (□/□) | product (b) (□/□) | Color |
| Preperative | 1,110 | 8.70 | 13.20 | White |
| Example 1 | | | | |
| Example 1 | 200 | 2.05 | 4.52 | White |
| Example 2 | 300 | 3.05 | 5.50 | White |
| Example 3 | 272 | 2.83 | 5.11 | White |
| Example 4 | 230 | 1.12 | 4.06 | White |
| Example 5 | 222 | 0.08 | 3.55 | White |
| Example 6 | 213 | 0 | 2.30 | White |
| Example 7 | 204 | 0 | 1.23 | White |
| Example 8 | 197 | 0 | 0.82 | White |
| Example 9 | 180 | 0 | 0.51 | White |
| Example 10 | 172 | 0 | 0.41 | White |
| Example 11 | 228 | 1.01 | 3.80 | White |
| Example 12 | 225 | 0.98 | 3.59 | White |
| Example 13 | 219 | 0.92 | 3.34 | White |
| Example 14 | 217 | 0.89 | 3.03 | White |
| Example 15 | 220 | 0.92 | 2.82 | White |
| Example 16 | 215 | 0.85 | 2.50 | White |
| Example 17 | 208 | 0.77 | 2.27 | White |
| Example 18 | 200 | 0.52 | 1.92 | White |
| Example 29 | 194 | 0.40 | 1.54 | White |
| Example 20 | 220 | 0.08 | 3.01 | White |
| Example 21 | 209 | 0 | 2.08 | White |

TABLE 2

| | | Amount of CH₂O | Amount of CH₂O | |
|---|---|---|---|---|
| | Amount of CH₂O | generated | generated | |
| | generated at | from molded | from molded | |
| Comparative | high temperature | product (a) | product (b) | |
| Example No. | (ppm) | (mg/kg) | (mg/kg) | Color |
| Comparative | 330 | 4.05 | 7.05 | White |
| Example 1 | | | | |
| Comparative | 150 | 0 | 0 | Yellow |
| Example 2 | | | | |
| Comparative | 328 | 3.90 | 6.74 | White |
| Example 3 | | | | |
| Comparative | 352 | 3.72 | 6.83 | Yellow |
| Example 4 | | | | |
| Comparative | 293 | 3.12 | 5.55 | Yellow |
| Example 5 | | | | |
| Comparative | 295 | 2.91 | 5.36 | Yellow |
| Example 6 | | | | |
| Comparative | 329 | 3.99 | 6.81 | Yellow |
| Example 7 | | | | |
| Comparative | 325 | 3.78 | 6.63 | Yellow |
| Example 8 | | | | |

As can be seen from the data shown in Table 1, the amounts of CH₂O generated from the polyoxymethylene resin compositions of Examples 1˜21 at a high temperature (222° C.) are from 172 ppm to 300 ppm, the amounts of CH₂O generated from the molded products (a) are from 0 to 3.05 mg/kg, and the amounts of CH₂O generated from the molded products (b) are from 0.41 to 5.50 mg/kg. No yellowing was observed in the molded products manufactured from the compositions of Examples 1 to 21. In contrast, it is obvious from the data shown in Table 2 that the amounts of CH₂O generated from the polyoxymethylene resin compositions of Comparative Examples 1 and 3 at a high temperature (222° C.) are 330 ppm and 328 ppm, respectively, the amounts of CH₂O generated from the molded products (a) are 4.05 and 3.90 mg/kg, respectively, and the amounts of CH₂O generated from the molded products (b) are 7.05 and 6.74 mg/kg, respectively. In conclusion, the polyoxymethylene resin compositions of Examples 1˜21 showed excellent thermal stability and reduced generation of CH₂O gas when compared to those of Comparative Examples 1 and 3. Further, yellowing was observed in the molded products manufactured from the compositions of Comparative Examples 2 and 4 to 8.

### INDUSTRIAL APPLICABILITY

As apparent from the foregoing description, the polyoxymethylene resin composition of the present invention is highly thermally stable, shows reduced generation of formaldehyde gas, particularly, during molding and from final molded products, and exhibits no yellowing in color.

1. A polyoxymethylene resin composition, comprising:
100 parts by weight of a polyoxymethylene polymer (A);
0.005˜2 parts by weight of an amine-substituted triazine compound (B);
0.01˜5 parts by weight of a compound (C) prepared by grafting 0.05˜5 parts by weight of anhydrous maleic acid onto an ethylene-propylene copolymer and an ethylene-propylene terpolymer; and
0.001˜2 parts by weight of 1,12-dodecanedicarboxylic acid dihydrazide (D).

2. The polyoxymethylene resin composition according to claim 1, wherein the amine-substituted triazine compound (B) is melamine.

3. The polyoxymethylene resin composition according to claim 1, wherein the ethylene-propylene copolymer and the ethylene-propylene terpolymer are present in a weight ratio of 10˜90:90˜10.

4. The polyoxymethylene resin composition according to claim 1, further comprising 0.01˜3 parts by weight of triethylene glycol-bis-3-(3-tert-butyl-4-hydroxy-5-methylphenyl)propionate, based on 100 parts by weight of the polyoxymethylene polymer.

5. The polyoxymethylene resin composition according to claim 2, further comprising 0.01˜3 parts by weight of triethylene glycol-bis-3-(3-tert-butyl-4-hydroxy-5-methylphenyl)propionate, based on 100 parts by weight of the polyoxymethylene polymer.

6. The polyoxymethylene resin composition according to claim 3, further comprising 0.01˜3 parts by weight of triethylene glycol-bis-3-(3-tert-butyl-4-hydroxy-5-methylphenyl)propionate, based on 100 parts by weight of the polyoxymethylene polymer.

7. (canceled)

8. (canceled)

9. (canceled)

10. (canceled)

11. The polyoxymethylene resin composition according to claim 1, further comprising 0.01˜1 parts by weight of magnesium hydroxide, based on 100 parts by weight of the polyoxymethylene polymer.

12. The polyoxymethylene resin composition according to claim 2, further comprising 0.01˜1 parts by weight of magnesium hydroxide, based on 100 parts by weight of the polyoxymethylene polymer.

13. The polyoxymethylene resin composition according to claim 3, further comprising 0.01˜1 parts by weight of magnesium hydroxide, based on 100 parts by weight of the polyoxymethylene polymer.

14. The polyoxymethylene resin composition according to claim 5, further comprising 0.01˜1 parts by weight of magnesium hydroxide, based on 100 parts by weight of the polyoxymethylene polymer.

15. The polyoxymethylene resin composition according to claim 4, further comprising 0.01˜1 parts by weight of magnesium hydroxide, based on 100 parts by weight of the polyoxymethylene polymer.

16. The polyoxymethylene resin composition according to claim 6, further comprising 0.01˜1 parts by weight of magnesium hydroxide, based on 100 parts by weight of the polyoxymethylene polymer.

17. A molded product manufactured from the polyoxymethylene resin composition according to claim 1.

18. A molded product manufactured from the polyoxymethylene resin composition according to claim 4.

19. A molded product manufactured from the polyoxymethylene resin composition according to claim 7.

20. A molded product manufactured from the polyoxymethylene resin composition according to claim 10.
